(19) United States
(12) Patent Application Publication
(10) Pub. No.: US 2008/0234408 A1
(43) Pub. Date: Sep. 25, 2008

(54) Novel method for producing an organoclay additive for use in polypropylene

(76) Inventors: David Abecassis, Huntington, NY (US); Ed Wiegel, Baltimore, MD (US)

Correspondence Address: Thomas A. O'Rourke;Bodner & O'Rourke, 425 Broadhollw Road, Melville, NY, 11747, US

(21) Appl. No.: 12/077,048

(22) Filed: Mar. 14, 2008

Related U.S. Application Data
(63) Continuation-in-part of application No. 11/801,993, filed on May 11, 2007.
Application No. 11/801,993 is a continuation-in-part of application No. 11/645,093, filed on Dec. 22, 2006.
(60) Provisional application No. 60/918,220, filed on Mar. 15, 2007.
(60) Provisional application No. 60/799,489, filed on May 11, 2006.

(51) Int. Cl. C08J 3/22

(52) U.S. Cl. 523/351

(57) ABSTRACT

The invention is direct to a method of forming a polyolefin blend. First a diphosphate and clay are blended to form an organoclay. The organoclay is blended with a vectoring polymeric material to form a masterbatch. The masterbatch is blended with a polyolefin such as a polyethylene or a polypropylene.

This application claims priority on U.S. Provisional Patent Application Ser. No. 60/918,220, filed Mar. 15, 2007, the disclosures of which are incorporated herein by reference. This application is a continuation in part of U.S. application Ser. No. 11/801,993 filed May 11, 2007, which claims priority on U.S. Provisional Application Ser. No. 60/799,489, filed on May 11, 2006, the disclosures of which are incorporated herein by reference. This application is also a continuation in part of U.S. application Ser. No. 11/645,093, filed Dec. 22, 2006, which claims priority on U.S. Provisional Application Ser. No. 60/733,678, the disclosures of which are incorporated herein by reference.

### FIELD OF THE INVENTION

The invention is directed towards the field of thermoplastics, blends thereof and thermoplastic processing. The invention pertains to the use of masterbatched RDP, BDP and -treated organoclay to make a variety of polyolefin nanocomposite materials for use as thermoplastics.

### BACKGROUND OF THE INVENTION

Polyolefins represent more than 20% of the worlds' total thermoplastics. Polyolefins include polypropylene and polyethylene thermoplastics as well as intermediate copolymers containing monomers from both species. Polypropylene has the better chemical and impact resistance of the two materials classes of materials and therefore finds service in many packaging materials for foods and chemicals. Polyethylene can tends to have mechanical and chemical properties which make it useful for lower grade commodity applications than polypropylene. Polyethylene is used in films and packaging material and has some mechanical applications, as well for household product components.

There has been much interest in performance additives which can improve polyolefin performance in areas ranging from flame retardant additives to mechanical and impact modifiers. UV degradation limits outdoor use for these plastics and improvements in UV field life are desirable. In addition these plastics are permeable to gases and vapor phase liquids so treatments for barrier properties are also desirable properties to add. It is for this reason that there has been much interest in the use of exfoliated organoclay nanocomposites since these show significant improvement in stiffness, UV, chemical and barrier resistance over unfilled virgin polyolefin resins.

Dispersion of the clay platelets/molecules in polyolefins is more difficult than other polyolefins due to the nature of their crystallinity. Clay co-additives such as expensive maleic anhydride-polymer derivatives have been used to better disperse traditional quaternary amine organoclays into polyolefins. Some polyolefin nanocomposites seek to overcome the dispersion issue by chemically grafting their polymer to the clay surface. Early research into RDP, BDP and RDP based-oligomers as organic treatments for montmorillonite and kaolin nanoclays showed little exfoliation if the clay was added directly to polyolefin thermoplastic. In addition, the additives tended to accumulate in tactoids. Thus, RDP, RDP oligomer bis(3-T-Butyl-4 hydroxyphenyl-2,4 Di-T-butylphenyl) resorcinol diphosphate, and BDP organoclays need a different strategy than straight addition, in order to take advantage full advantage of their nanoclay exfoliating behavior. Accordingly, there is a need to successfully form nanocomposite materials with polyolefin thermoplastics.

### OBJECTS OF THE INVENTION

It is an object of the invention to form a thermoplastic nanocomposite with an organoclay.

It is another object of the invention to form a nanocomposite of a polyolefin with an organoclay.

Still another object of this invention is to enable better blending of polyolefins into a micro-composite blend.

A still further object of the invention is to produce a low cost nanocomposite polyolefin.

It is also an object of this invention is to produce a barrier material for handling liquids and gases.

A further object of the invention is to produce materials with improved mechanical properties which allow for new uses of polyolefins in engineering plastic applications.

### SUMMARY OF THE INVENTION

The present invention is directed to a method of forming improved polyolefin blends. These blends are formed from an organoclay and a polyolefin. The organoclay is a blend of a clay and a diphosphate. The clay is preferably a smectite clay. The smectite clay can be a natural or synthetic clay mineral selected from the group consisting of hectorite, montmorillonite, bentonite, beidetite, saponite, stevensite and mixtures thereof. Montmorillonite is a preferred smectite clay. The preferred method of forming the composition of the invention can have about three processing steps The first step is the making of the organoclay. The organoclay is then compounded into a vectoring masterbatch thermoplastic, then finally adding the organoclay laden compounded masterbatch is added to the polyolefin resins.

The present invention includes forming an exfoliated clay by blending a clay with a diphosphate. The diphosphate can include resorcinol diphosphate (RDP), RDP oligomer bis(3-T-Butyl-4 hydroxyphenyl-2,4 Di-T-butylphenyl) resorcinol diphosphate or bisphenol diphosphate (BDP). The diphosphate such as resorcinol diphosphate coats at least a portion of the surface of the clay platelet, thereby providing improved exfoliation to the clay. Alternatively, the clay platelet may be blended with bisphenol diphosphate (BDP) to provide improved exfoliation. The chemical exfoliants used in the invention have no precedent in their use which would have indicated their applicability for such dispersion. Issued patents for BDP deal with it's use as a flame retardant or as a precursor for polycarbonate synthesis. As for the RDP; it's described uses are as a flame retardant additive or as a plasticizer for plastic impact modification. RDP is often used in conjunction with complex multicomponent packages designed to boost plastic mechanical or flame retardant properties.

The present invention also includes the composition formed from the blending of the clay with either resorcinol diphosphate or bisphenol diphosphate or blends thereof. In a preferred composition, there is about 99% to about 50% clay with the balance RDP. Similarly, another preferred composition is 99% to about 50% BDP. In this invention, the RDP or BDP or blends thereof physically coat the clay platelet and allows it to exfoliate. While it is possible to have compositions with more than 50% RDP or BDP, in such compositions the RDP and/or BDP acts as a plasticizer which may not always be a desired property for the particular application.

Other preferred compositions include blends of 95% to about 70% clay with the balance RDP and/or BDP.

In forming the blends of the present invention, it is preferred that the diphosphate material be heated to about 50° C. to about 100° before it is blended with the clay. The liquid diphosphate can be sprayed on to the clay and then the composition can be mechanically mixed to blend the materials together. Other means of mixing the clay and the diphosphate can be employed. It is also preferred that the diphosphate be heated to a temperature below its vapor point so that the diphosphate material is not lost.

Once the clay has been exfoliated by blending with RDP or BDP, the composition can be used in a variety of masterbatch vectoring polymers to facilitate blending the organoclay with the polyolefin. To create the masterbatch, the blend of diphosphate and clay is blended with a vectoring polymer. Suitable vectoring polymers include polymethyl methacrylate (PMMA), acrylonitrite butadiene styrene (ABS), high impact polystyrene (HIPS) and ethylene vinyl acetate (EVA). In a preferred embodiment, there is about 1% to about 25% by weight of the exfoliated clay blend with the balance the vectoring polymeric material such as PMMA, ABS, HIPS or EVA.

After the organoclay has been blended with the vectoring polymer, the resultant masterbatch blend is mixed with the selected polyolefin. The masterbatch blend of organoclay and vectoring material are combined with a polyolefin. The polyolefin may be polyethylene and blends thereof. In addition, other olefins may be used as well as blends of polyolefins. The masterbatch blend of organoclay and the vectoring material is blended with the polyolefin in an amount of about 1% to about 30% by weight masterbatch with the balance polyolefin. A more preferred blend has about 1% by weight to about 15% by weight masterbatch with the balance polyolefin.

The present invention may also be used with organoclays as well to enhance their exfoliation. When the diphosphate is blended with the clay, exfoliation of the clay occurs. The masterbatch of the present invention permits the exfoliated clay to become dispersed into the polyolefin. For example, in order to enhance exfoliation in thermoplastics where this does normally not occur, the RDP/and or BDP treated clay is pre-compounded into acetyl butyldiene styrene (ABS) copolymer where its exfoliation rate is high. A pellet of this blend is formed. This concentrated pellet of clay and polymer can be used as an additive with success in thermoplastics where the RDP and or BDP treated organoclay does not perform well on it's own without this pre-compounding step.

The improved polymer exfoliates clay blends of the present invention may be used in a variety of applications. The properties of the polymer blends of the present invention includes improved barrier properties including water and oxygen barrier properties. There are also improved vapor and moisture barrier properties in these compositions. The compositions of the present invention also have increased UV stability and improved flame retardant properties. The compositions of the present invention also have improved processability. The exfoliated clay in the polymer keeps the viscosity of the polyolefin nanocomposite higher at higher temperatures with less back flow in extrusion and injection molding equipment.

### BRIEF DESCRIPTION OF THE DRAWINGS

FIG. 1 shows a TEM image for a sample called PP+PMMA-MB.

### DETAILED DESCRIPTION OF THE INVENTION

RDP, BDP and RDP oligomer organoclays have high exfoliation rates in certain preferred thermoplastics such as PMMA, ABS, EVA and HIPS. Therefore the RDP clay, BDP clay or RDP oligomer-clay(bis(3-T-Butyl-4 hydroxyphenyl-2,4 Di-T-butylphenyl) resorcinol diphosphate) or a combination thereof is added to the preferred plastic in loading rates from 5%-45% clay/masterbatch polymer, and then the RDP, BDP, RDP-oligomer-clay laden polymer is added to the polyolefin as a masterbatch additive in thermoplastic pellet form.

The result is a polyolefin nanocomposite where the clay is exfoliated in the vectoring plastic and the vectoring plastic is dispersed inside the polyolefin. The resulting material is comprised of a majority of polyolefin polymer with the vectoring masterbatch polymer dispersed along with the clay uniformly throughout the polyolefin matrix.

The clays used in the present invention are typically a smectite clay. A smectite clay is a natural or synthetic clay mineral selected from the group consisting of hectorite, montmorillonite, bentonite, beidelite, saponite, stevensite and mixtures thereof. A particularly preferred choice for the smectite is montmorillonite. Kaolin clays such as halloysite can be used as well.

The present invention is an organic treatment carried out typically in a twin processing step, which replaces the need for multi-stage chemical treatments and elaborate processing of the polymer in order to obtain homogeneity of the final nano-composite material when the additive is mixed with a polymer.

The present invention includes a first step of forming an exfoliating clay by blending a clay with a diphosphate such as resorcinol diphosphate (RDP). The diphosphate coats at least a portion of the surface of the clay platelet, thereby providing improved exfoliation of the clay. Alternatively, the clay platelet may be blended with bisphenol diphosphate (BDP) or a blend of RDP and BDP. The diphosphate is preferably coated onto the clay platelets by spraying or other suitable means. The diphosphate is preferably preheated to a temperature of about 50° C to about 100° C.

The present invention also includes the composition formed from the blending of the clay with either resorcinol diphosphate or bisphenol diphosphate or blends thereof. In a preferred composition, there is about 99% to about 50% clay with the balance a diphosphate such as RDP. Similarly, another preferred composition is 99% to about 50% BDP. In this invention, the RDP or BDP or blends thereof physically coat at least a portion of the clay platelet and allows the clay platelet to exfoliate. Similar compositions may be used with blends of diphosphate and clay. While it is possible to have compositions with more than 50% by weight RDP or BDP, in such compositions the RDP and/or BDP tends to act as a plasticizer which may not always be a desired property for the particular application. Other preferred compositions include blends of 99% to about 80% clay with the balance RDP and/or BDP.

In forming the blends of the present invention, it is preferred that the diphosphate material be heated to about 50° C. to about 100°. It is also preferred that the diphosphate be heated to a temperature below its vapor point so that the diphosphate material is not vaporized. The liquid diphosphate can then be sprayed on to the clay. It can also be added at room temperature if the particles are fluidized in a solid particle vortex. For example. when montmorillonite clays are dry they exhibit semi-fluid behavior. They pour more like a liquid than a particle. With suitable high shear dry mixing equipment, the clay can be fluidized prior to adding the organic phosphate surface treatment The composition containing the clay and the diphosphate can be mechanically mixed to blend the materials together. Other suitable means of mixing the clay and the diphosphate can be employed.

Once the organoclay is formed it is compounded with the ABS, EVA, HIPS, or PMMA and pelletized for use as a polyolefin additive masterbatch using a twin or high shear single screw extruder or other suitable melt compounding methods. The pellets resulting from the clay addition to the masterbatch plastic in the second step are added to the polyolefin in a third compounding step.

### EXAMPLES

The control was polypropylene. In the first blend, PP+PMMA-MB (Masterbatch), the polypropylene was treated with 11% PMMA masterbatch. The PMMA masterbatch had 45% by weight organoclay with the balance PMMA. RDP is 10% by weight of the organoclay. Thus the PMMA masterbatch had 55% PMMA 4.5% RDP and 40.5% clay. The overall blend was 11% PMMA masterbatch and 89% polypropylene.

The second blend was made up of 15% masterbatch and 85% high density polyethylene. The masterbatch was a PMMA masterbatch where there was 33.3% organoclay and 66.7% PMMA. The RDP was 10% of the organoclay and the remaining 90% of the organoclay was clay.

The third composition had a polyolefin blend of 80% by weight polypropylene/20% weight high density polyethylene. The blend of the present invention was made up of 15% masterbatch and 85% polyolefin. The masterbatch was a PMMA masterbatch where there was 33.3% organoclay and 66.7% PMMA. The RDP was 10% of the organoclay and the remaining 90% of the organoclay was clay.

All tests are standard ASTM tests.

| | | | | 80% PP + 20% |
|---|---|---|---|---|
| | | PP + | HDPE + | HDPE- |
| Material | Control PP | PMMA-MB | PMMA MB | PMMA-MB |
| Flexural | 111659 | 134065 | 162644 | 169463 |
| Modulus | | | | |
| Tensile@ | 3538 | 3371 | 3424 | 3675 |
| yield | | | | |
| Tensile@ | 3481 | 2167 | 1919 | 2124 |
| break | | | | |
| Notched | 0.949 | 0.85 | 0.93 | 0.85 |
| Izod Imp. | | | | |
| Specific | 0.8956 | 0.934 | 0.993 | 0.96 |
| gravity | | | | |

PP = polypropylene
PMMA = polymethyl methacrylate
HDPE = high density polyethylene

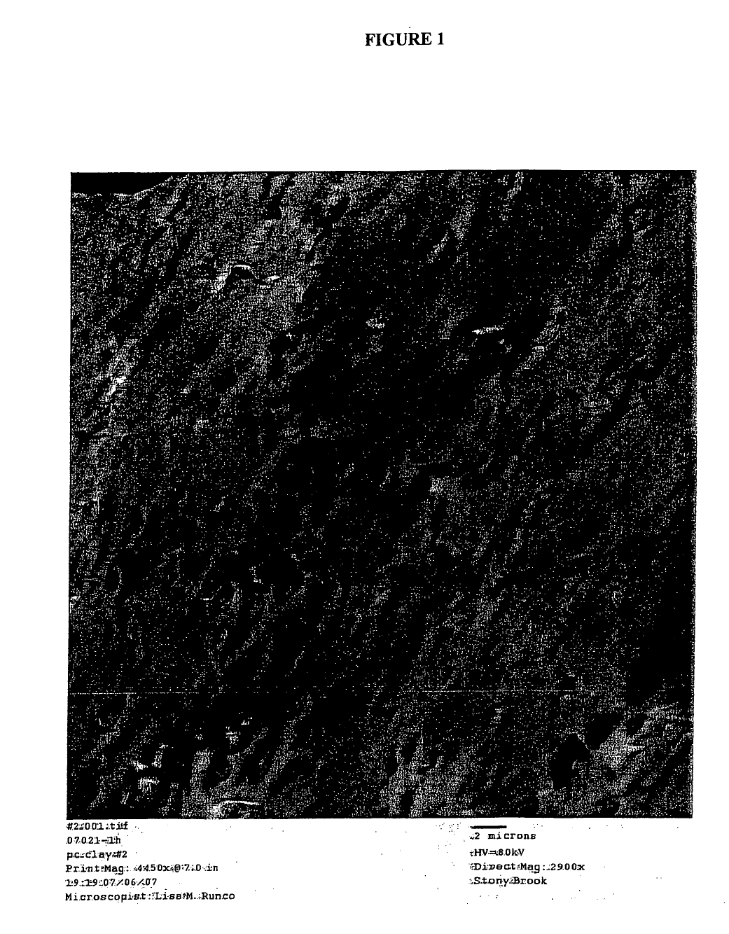

The first nanocomposite sample called PP+PMMA-MB has TEM image shown in FIG. 1 which clearly shows the PMMA masterbatch dispersed throughout the polypropylene. Though the high loading rate in the PMMA results in tactoid formation, individual platelets can become encapsulated in the PMMA and dispersed away from the PMMA phase as PMMA encapsulated exfoliated clay molecules with shear.

What is claimed:

1. A method of forming a polyolefin blend comprising blending a diphosphate with a clay to form an organoclay, blending said organoclay with a vectoring polymeric material to form a masterbatch, blending said masterbatch with a polyolefin.

2. The method according to claim 1 wherein said diphosphate is resorcinol diphospahte, bisphenol diphosphate or blends thereof.

3. The method according to claim 2 wherein said vectoring polymeric material is selected from the group consisting of polymethyl methacrylate (PMMA), acrylonitrite butadiene (ABS), high impact polystyrene (HIPS) and ethylene vinyl acetate.

4. The method according to claim 3 wherein said organoclay has about 50% by weight to about 99% by weight clay the balance diphosphate.

5. The method according to claim 4 wherein said masterbatch comprises about 1% by weight to about 25% by weight organoclay and the balance vectoring polymeric material.

6. The method according to claim 5 wherein the blend comprises % by weight masterbatch and the balance polyolefin.

7. The method according to claim 6 wherein said diphosphate is heated to a temperature of about 50° C. to about 100° C. prior to blending with the clay.

8. The method according to claim 7 wherein the heated diphosphate is sprayed onto said clay.

9. The method according to claim 8 wherein the masterbatch is formed into pellets after the organoclay is blended with the vectoring polymeric material.

10. The method according to claim 9 wherein said polyolefing is polypropylene, polyethylene or blends thereof.

11. A polyolefin blend comprising a blend of a polyolefin and a masterbatch, said masterbatch being comprised of an organoclay and a vectoring polymeric material, said organoclay being comprised of a blend of a diphosphate and a clay.

12. The blend according to claim 11 wherein said diphosphate is resorcinol diphospahte, bisphenol diphosphate or blends thereof.

13. The blend according to claim 12 wherein said vectoring polymeric material is selected from the group consisting of polymethyl methacrylate (PMMA), acrylonitrite butadiene (ABS), high impact polystyrene (HIPS) and ethylene vinyl acetate.

14. The blend according to claim 13 wherein said organoclay has about 50% by weight to about 99% by weight clay the balance diphosphate.

15. The blend according to claim 14 wherein said masterbatch comprises about 1% by weight to about 25% by weight organoclay and the balance vectoring polymeric material.

16. The blend according to claim 15 wherein the blend comprises % by weight masterbatch and the balance polyolefin.

17. The blend according to claim 16 wherein said diphosphate is heated to a temperature of about 50° C. to about 100° C. prior to blending with the clay.

18. The blend according to claim 17 wherein the heated diphosphate is sprayed onto said clay.

19. The blend according to claim 18 wherein the masterbatch is formed into pellets after the organoclay is blended with the vectoring polymeric material.

20. The blend according to claim 19 wherein said polyolefing is polypropylene, polyethylene or blends thereof.
